(19) United States
(12) Patent Application Publication
(10) Pub. No.: US 2016/0356508 A1
(43) Pub. Date: Dec. 8, 2016

(54) AIR CONDITIONER COMPRESSOR COVER

(71) Applicant: Dan Nguyen, Martinez, GA (US)

(72) Inventor: Dan Nguyen, Martinez, GA (US)

(21) Appl. No.: 14/733,668

(22) Filed: Jun. 8, 2015

(51) Int. Cl. F24F 1/56; B23P 19/00

(52) U.S. Cl. CPC F24F 1/56; B23P 19/00

(57) ABSTRACT

Implementations of an air conditioner compressor cover are provided. In some implementations, the air conditioner compressor cover may comprise a first piece of material sized to cover a first portion of a top opening of an air conditioner compressor unit and a second piece of material sized to cover a second portion of the top opening of the air conditioner compressor unit. A portion of a first side of the first piece of material is connected to the air conditioner compressor unit with hinges and a portion of a first side of the second piece of material is connected to the air conditioner compressor with hinges on opposing sides of the air conditioner compressor unit such that when air is not blowing out of the top opening of the air conditioner compressor unit, a second side of the first piece of material and a second side of the second piece of material rest adjacent to each other and when air begins to blow out of the top opening of the air conditioner compressor unit, the first piece of material rotates about its hinges in a first direction and the second piece of material rotates about its hinges in a second direction that is opposite from the first direction.

### TECHNICAL FIELD

This disclosure relates to implementations of an air conditioner compressor cover.

### BACKGROUND

Typical air conditioner compressor units include a rectangular housing with openings on the top and sides for air circulation. Because of the openings in the housing, debris (e.g., leaves dirt, etc.) and precipitation (e.g., rain, snow) can get inside these units.

Existing covers for air conditioner compressor units are either manually operated, not designed to be used on the units while the units are operational, or have a complex design.

For example, U.S. Pat. No. 4,953,328 discloses a manually operated cover that comprises a ceiling having a plurality of rows of shutters and means for retaining each of said rows of shutters in an open position. As another example, U.S. Pat. No. 6,397,617 discloses a cover having a magnet attached thereto to secure the cover to the air conditioning unit when the unit is not in operation. The '617 patent discloses that upon activation of the fan within the air conditioning unit, the cover is immediately blown away from the unit. As yet another example, U.S. Pat. No. 8,357,031 discloses a complex cover having rotatably mounted, interleaved vanes that are capable of being forced into an open position by air currents being forced through the air conditioner unit by a fan.

### BRIEF DESCRIPTION OF THE DRAWINGS

FIGS. 1A and 1B illustrate an example implementation of an air conditioner compressor cover for covering the top of an air conditioner compressor unit according to the principles of the present disclosure.

### DETAILED DESCRIPTION

Implementations of an air conditioner compressor cover are provided. In some implementations, the air conditioner compressor cover may comprise a first piece of material sized to cover a first portion of a top opening of an air conditioner compressor unit and a second piece of material sized to cover a second portion of the top opening of the air conditioner compressor unit. In some implementations, the cover may further comprise one or more attachment devices configured to attach the first piece of material to the air conditioner compressor unit and one or more attachment devices configured to attach the second piece of material to the air conditioner compressor unit. In some implementations, the one or more attachment devices comprise hinges. In some implementations, the one or more attachment devices further comprise double sided tape. In some implementations, the first piece of material and the second piece of material are corrugated plastic sheets.

In some implementations, the method of covering an air conditioner compressor using the cover comprises connecting a portion of a first side of the first piece of material to the air conditioner compressor unit and connecting a portion of a first side of the second piece of material to the air conditioner compressor unit such that the first piece of material and the second piece of material are connected to the air conditioner compressor unit on opposing sides of the air conditioner compressor unit and when air is not blowing out of the top opening of the air conditioner compressor unit, a second side of the first piece of material and a second side of the second piece of material rest adjacent to each other and when air begins to blow out of the top opening of the air conditioner compressor unit, the first piece of material rotates about its hinges in a first direction and the second piece of material rotates about its hinges in a second direction that is opposite from the first direction.

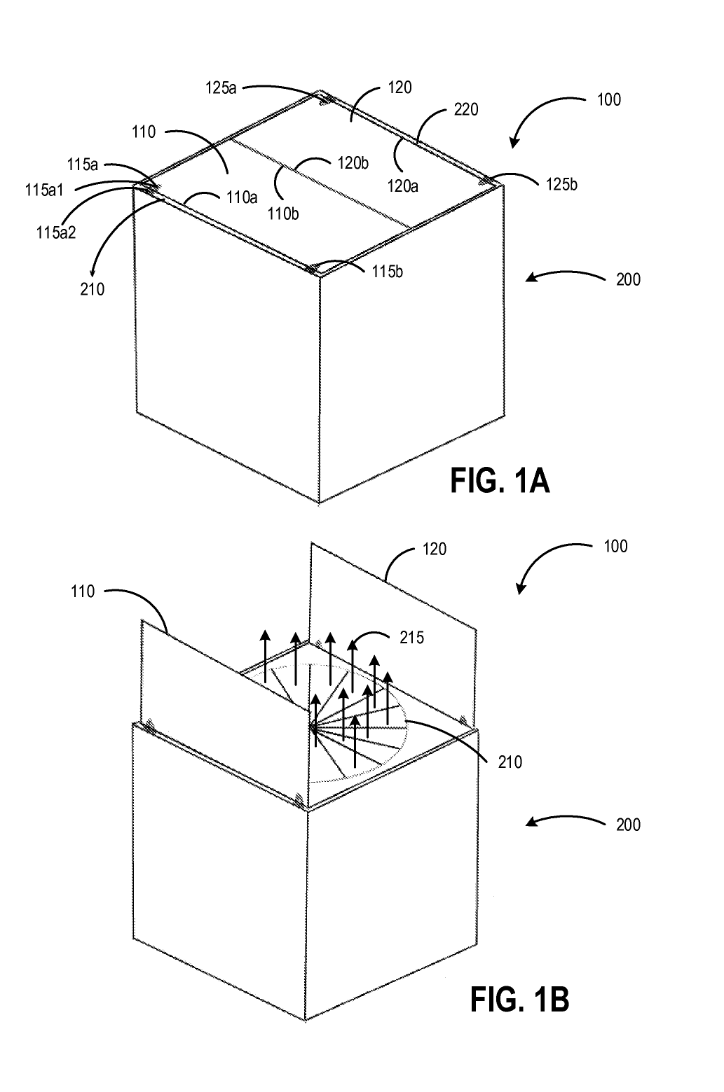

FIGS. 1A and 1B illustrate an example implementation of an air conditioner compressor cover 100 for covering the top of an air conditioner compressor unit 200 according to the principles of the present disclosure.

In some implementations, the cover 100 may be configured to cover the top opening 210 of the air conditioner compressor unit 200 where air circulates. In some implementations, the cover 100 may be configured to cover a portion of the top opening 210 of the air conditioner compressor unit 200 where air circulates. In some implementations, the cover 100 may be configured to cover the top surface or a portion of the top surface including the top opening 210 or a portion thereof of the air conditioner compressor unit 200.

In some implementations, the air conditioner compressor cover 100 may comprise a first piece of material 110 sized to cover a first portion of a top opening 210 of an air conditioner compressor unit 200; a second piece of material 120 sized to cover a second portion of the top opening 210 of the air conditioner compressor unit 200; one or more hinges 115a, 115b attached to the first piece of material 110 and the air conditioner compressor unit 200; and one or more hinges 125a, 125b attached to the second piece of material 120 and the air conditioner compressor unit 200.

In some implementations, the first piece of material 110 and the second piece of material 120 may be rectangular in shape. In some implementations, the first piece of material 110 and the second piece of material 120 may be any suitable shape to cover the top opening 210 or a portion thereof of the air conditioner compressor unit 200. In some implementations, the first piece of material 110 and the second piece of material 120 may be flat.

In some implementations, a portion of a first side 110a of the first piece of material 110 may be connected to the air conditioner compressor unit 200 and the remaining sides may be detached from the air conditioner compressor unit 200. As discussed above, in some implementations, the first piece of material 110 may be connected to the air conditioner compressor unit 200 with one or more hinges 115a, 115b. In this way, when air 215 begins to blow out of the top opening 210, the first piece of material 110 may rotate about the hinge(s) in a first direction.

In some implementations, a first part (see e.g., 115a1) of the hinges 115a, 115b may be attached to first side 110a of the first piece of material 110 using double side tape. In this way, screws are not required to attach the first part of the hinges to the first piece of material 110. In some implementations, a second part (see e.g., 115a2) of the hinges 115a, 115b may be attached to air conditioner compressor unit 200. In some implementations, the second part of the hinges 115a, 115b may be directly attached to the air conditioner compressor unit 200. In some implementations, the second part of the hinges 115a, 115b may be indirectly attached to the air conditioner compressor unit 200. In some implementations, the second part of the hinges 115a, 115b may be secured to a block of material (e.g., wood, plastic, or any other suitable material), and the block of material may be secured to the air conditioner compressor unit 200. In some implementations, the block of material may be used to keep the first piece of material 110 level when attaching to the air conditioner compressor unit 200. In some implementations, the block of material may be secured to the air conditioner compressor unit 200 using double sided tape. In some implementations, the second part of the hinges 115a, 115b may be secured to the block of material or the air conditioner compressor unit 200 using screws. In some implementations, the second part of the hinges 115a, 115b may be secured to the block of material or directly to the air conditioner compressor unit 200 using double sided tape. In this way, screws are not required to attach the second part of the hinges to the block of material or the air conditioner compressor unit 200.

Similarly, in some implementations, a portion of a first side 120a of the second piece of material 120 may be connected to the air conditioner compressor unit 200 and the remaining sides may be detached from the air conditioner compressor unit 200. Furthermore, in some implementations, the second piece of material 120 may be connected to the air conditioner compressor unit 200 with one or more hinges 125a, 125b. In some implementations, the first piece of material 110 and the second piece of material 120 may be connected to the air conditioner compressor unit 200 on opposing sides 210, 220, respectively, of the air conditioner compressor unit 200. In this way, when air is not blowing out of the top opening 210, a second side 110b of the first piece of material 110 and a second side 120b of the second piece of material 120 may rest adjacent to each other, and when air 215 begins to blow out of the top opening 210, the second piece of material 120 may rotate about the hinge(s) in a second direction that is opposite the first direction.

Similarly, In some implementations, a first part of the hinges 125a, 125b may be attached to first side 120a of the second piece of material 120 using double side tape. In this way, screws are not required to attach the first part of the hinges to the second piece of material 120. In some implementations, the second part of the hinges 125a, 125b may be attached to air conditioner compressor unit 200. In some implementations, the second part of the hinges 125a, 125b may be directly attached to the air conditioner compressor unit 200. In some implementations, the second part of the hinges 125a, 125b may be indirectly attached to the air conditioner compressor unit 200. In some implementations, the second part of the hinges 125a, 125b may be secured to a block of material (e.g., wood, plastic, or any other suitable material), and the block of material may be secured to the air conditioner compressor unit 200. In some implementations, the block of material may be used to keep the second piece of material 120 level when attaching to the air conditioner compressor unit 200. In some implementations, the block of material may be secured to the air conditioner compressor unit 200 using double sided tape. In some implementations, the second part of the hinges 125a, 125b may be secured to the block of material or the air conditioner compressor unit 200 using screws. In some implementations, the second part of the hinges 125a, 125b may be secured to the block of material or directly to the air conditioner compressor unit 200 using double sided tape. In this way, screws are not required to attach the second part of the hinges to the block of material or the air conditioner compressor unit 200.

As shown in FIG. 1A, in some implementations, when air is not blowing out the top opening 210 of the air conditioner compressor unit 200, the first piece of material 110 and the second piece of material 120 are configured to cover the top opening 210.

As shown in FIG. 1B, when air 215 is blowing out of the top opening 210, the air 215 may push the pieces of material 110, 120 upward thereby causing the material 110, 120 to rotate about the hinges and remain upright until the air is not blowing out of the top opening 210. In some implementations, the first piece of material 110 and the second piece of material 120 may be a rigid, lightweight plastic sheet or board. In some implementation, the first piece of material 110 and the second piece of material 120 may be a corrugated plastic sheet. In some implementations, the first piece of material 110 and the second piece of material 120 may be any suitable material that is rigid and light enough to be lifted by the air blowing out of the top opening 210. In some implementations, the first piece of material 110 and the second piece of material 120 may be 4 mm thick. In some implementations, the first piece of material 110 and the second piece of material 120 may be thinner or thicker.

In some implementations, the hinge(s) 115, 125 may limit the rotation of the first piece of material 110 and the second piece of material 120, respectively.

When the air stops blowing out of the top opening 210, the hinges and/or gravity may cause the first piece of material 110 and the second piece of material 120 to return to their original resting position shown in FIG. 1A.

In some implementations, any suitable currently existing or future developed attachment device may be used to connect the first piece of material 110 and the second piece of material 120 to the air conditioner compressor unit 200.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An air conditioner compressor cover comprising:
a first piece of material sized to cover a first portion of a top opening of an air conditioner compressor unit;
a second piece of material sized to cover the remaining portion of the top opening of the air conditioner compressor unit;
one or more attachment devices configured to attach the first piece of material to the air conditioner compressor unit; and
one or more attachment devices configured to attach the second piece of material to the air conditioner compressor unit.

2. The cover of claim 1 wherein the first piece of material and the second piece of material are corrugated plastic sheets.

3. The cover of claim 1 wherein the one or more attachment devices configured to attach the first piece of material to the air conditioner compressor unit comprises one or more first hinges and the one or more attachment devices configured to attach the second piece of material to the air conditioner compressor unit comprises one or more second hinges.

4. The cover of claim 3 wherein the one or more attachment devices configured to attach the first piece of material to the air conditioner compressor unit further comprises double sided tape and the one or more attachment devices configured to attach the second piece of material to the air conditioner compressor unit further comprises double sided tape.

5. An air conditioner compressor cover comprising:
a first piece of material sized to cover a first portion of a top opening of an air conditioner compressor unit;
a second piece of material sized to cover a second portion of the top opening of the air conditioner compressor unit;
one or more attachment devices configured to attach the first piece of material to the air conditioner compressor unit; and
one or more attachment devices configured to attach the second piece of material to the air conditioner compressor unit.

6. The cover of claim 5 wherein the first piece of material and the second piece of material are corrugated plastic sheets.

7. The cover of claim 5 wherein the one or more attachment devices configured to attach the first piece of material to the air conditioner compressor unit comprises one or more first hinges and the one or more attachment devices configured to attach the second piece of material to the air conditioner compressor unit comprises one or more second hinges.

8. The cover of claim 7 wherein the one or more attachment devices configured to attach the first piece of material to the air conditioner compressor unit further comprises double sided tape and the one or more attachment devices configured to attach the second piece of material to the air conditioner compressor unit further comprises double sided tape.

9. A method of covering an air conditioner compressor using the cover of claim 5, the method comprising:
connecting a portion of a first side of the first piece of material to the air conditioner compressor unit and connecting a portion of a first side of the second piece of material to the air conditioner compressor unit such that the first piece of material and the second piece of material are connected to the air conditioner compressor unit on opposing sides of the air conditioner compressor unit and when air is not blowing out of the top opening of the air conditioner compressor unit, a second side of the first piece of material and a second side of the second piece of material rest adjacent to each other.

10. The method of claim 9 wherein the first piece of material is connected to the air conditioner compressor unit with one or more first hinges and the second piece of material is connected to the air conditioner compressor unit with one or more second hinges such that when air begins to blow out of the top opening of the air conditioner compressor unit, the first piece of material rotates about its hinges in a first direction and the second piece of material rotates about its hinges in a second direction that is opposite from the first direction.

11. The method of claim 10 wherein a first part of each of the one or more first hinges are connected the first piece of material using double sided tape and a first part of each of the one or more second hinges are connected the second piece of material using double sided tape.

12. The method of claim 11 wherein the second part of each of the one or more first hinges are secured to a block of material and the block of material is secured to the air conditioner compressor unit using double sided tape and wherein the second part of each of the one or more second hinges are secured to a block of material and the block of material is secured to the air conditioner compressor unit using double sided tape.

13. The method of claim 11 wherein the second part of each of the one or more first hinges are secured the air conditioner compressor unit using double sided tape and wherein the second part of each of the one or more second hinges are secured to the air conditioner compressor unit using double sided tape.

14. An air conditioner compressor unit and cover comprising:
an air conditioner compressor unit; and
a cover wherein the cover comprises a first piece of material sized to cover a first portion of a top opening of the air conditioner compressor unit; a second piece of material sized to cover a second portion of the top opening of the air conditioner compressor unit; one or more attachment devices configured to attach the first piece of material to the air conditioner compressor unit; and one or more attachment devices configured to attach the second piece of material to the air conditioner compressor unit;
wherein a portion of a first side of the first piece of material is connected to the air conditioner compressor unit and a portion of a first side of the second piece of material is connected to the air conditioner compressor on opposing sides of the air conditioner compressor unit such that when air is not blowing out of the top opening of the air conditioner compressor unit, a second side of the first piece of material and a second side of the second piece of material rest adjacent to each other.

15. The air conditioner compressor unit and cover of claim 14 wherein the first piece of material is connected to the air conditioner compressor unit with one or more first hinges and the second piece of material is connected to the air conditioner compressor unit with one or more second hinges such that when air begins to blow out of the top opening of the air conditioner compressor unit, the first piece of material rotates about its hinges in a first direction and the second piece of material rotates about its hinges in a second direction that is opposite from the first direction.

16. The air conditioner compressor unit and cover of claim 15 wherein the first piece of material and the second piece of material are corrugated plastic sheets.

17. The air conditioner compressor unit and cover of claim 15 wherein a first part of each of the one or more first hinges are connected the first piece of material using double sided tape and a first part of each of the one or more second hinges are connected the second piece of material using double sided tape.

18. The air conditioner compressor unit and cover of claim 17 wherein the second part of each of the one or more first hinges are secured to a block of material and the block of material is secured to the air conditioner compressor unit using double sided tape and wherein the second part of each of the one or more second hinges are secured to a block of material and the block of material is secured to the air conditioner compressor unit using double sided tape.

19. The air conditioner compressor unit and cover of claim 17 wherein the second part of each of the one or more first hinges are secured the air conditioner compressor unit using double sided tape and wherein the second part of each of the one or more second hinges are secured to the air conditioner compressor unit using double sided tape.
